(19) United States
(12) Patent Application Publication
(10) Pub. No.: US 2019/0320614 A1
(43) Pub. Date: Oct. 24, 2019

(54) APPARATUS FOR DISTRIBUTING FEED IN FARMING SHEDS AND METHODS FOR DISTRIBUTING FEED WITH THE APPARATUS

(71) Applicant: OFFICINE FACCO & C. S.P.A., Campo San Martino (IT)

(72) Inventors: Massimo FINCO, Padova (IT); Luca FINCO, Chicago, IL (US)

(21) Appl. No.: 16/391,567

(22) Filed: Apr. 23, 2019

(30) Foreign Application Priority Data
Apr. 24, 2018 (IT) 102018000004808

(51) Int. Cl. A01K 5/02; A01K 5/01; A01K 39/012

(52) U.S. Cl. CPC A01K 5/0225; A01K 39/012; A01K 5/01

(57) ABSTRACT

An apparatus for distributing feed, comprising:
at least one line for the distribution of feed from at least one storage location to a series of dispensers for dispensing the feed to the cages of animals,
at least one feed container which affects the line upstream and downstream of the dispensers respectively for the loading and discharging of feed, on the part of the line, not released to the dispensers,
means for detecting the level of feed inside the container,
at least one control system adapted to receive filling information of the feed container from the detection means and to control the loading of the line with feed from the storage location or from the feed container and to set the travel speed of the line.

The present invention relates to an apparatus for distributing feed in farming sheds and to methods for distributing feed with said apparatus.

Currently, poultry facilities are very large and therefore also very complex from a plant engineering perspective. In order to improve their management, they have been provided with automated systems, for example for watering and for feeding the animals.

In such facilities it is in fact necessary to distribute several times a day in an automated manner the feed necessary for the survival and the wellbeing of the animals that occupy them.

The facilities are divided internally into modules and rows, in order to create groups of animals that are fed by feed distribution lines or systems arranged inside the facility itself and provided for example with means such as chains, carriages, screw feeders.

The feed necessary for feeding the animals, therefore to be distributed to the various feed lines internal to the apparatus, is generally drawn from a storage location arranged outside the shed, usually consisting of a series of silos.

The silos are provided with gate valves at which the distribution lines are fed.

Two main types of distribution system are currently commercially available.

According to one of these, a distribution line, or more than one, brings the feed from the silos inside of the facility to feed in series internal feed lines that bring the food to respective rows of cages.

The other one instead provides for a distribution line, or more than one, designed to feed an internal loop line, which in turn discharges the feed in various internal lines arranged in parallel, thus feeding simultaneously multiple internal feed lines.

The first distribution system has a significant drawback in that different lengths of the feed lines correspond to a different quantity of feed. In order to feed all the rows of cages, it is necessary to oversize the distribution while however avoiding that after the last row of cages there is still feed on the line, in order to not overstress the driving motor.

The second system requires at least two circuits (one for loading the internal loop line and one constituted by the loop itself) in order to reach the lines for distribution to the rows of cages and therefore, in case of failures of one of the two, the system is not able to distribute the feed to the various internal lines. In order to obtain a safety redundancy, four circuits are necessary.

The aim of the present invention is to provide an apparatus for distributing feed that is capable of improving the background art in one or more of the aspects mentioned above.

Within this aim, an object of the invention is to provide an apparatus for distributing feed and to propose a method for distributing with said apparatus, which allows to avoid the overloading of the system with excess feed, in order to ensure a long life of the components of the apparatus.

Another object of the invention is to ensure an adequate supply of feed to all the internal lines for distribution to the rows of cages.

Another object of the invention is to minimize the number of feeding line by ensuring a continuous supply of feed to the animals, even in case of maintenance on one of the lines.

Moreover, an object of the present invention is to overcome the drawbacks of the background art in a manner that is alternative to any existing solutions.

Another object of the invention is to provide an apparatus that is highly reliable, relatively easy to provide and at competitive costs.

This aim and these and other objects which will become better apparent hereinafter are achieved by an apparatus for distributing feed in farming sheds, characterized in that it comprises:
at least one line for the distribution of feed from at least one storage location to a series of dispensers for dispensing the feed to the cages of animals,
at least one feed container which affects said line upstream and downstream of said dispensers respectively for the loading and discharging of feed, on the part of said line, not released to said dispensers,
means for detecting the level of feed inside said container,
at least one control system adapted to receive filling information of said feed container from said detection means and to control the loading of said line with feed from said storage location or from said feed container and to set the travel speed of said line.

Further characteristics and advantages of the invention will become better apparent from the description of a preferred but not exclusive embodiment of the apparatus for distributing feed according to the invention, illustrated by way of non-limiting example in the accompanying drawings, wherein:

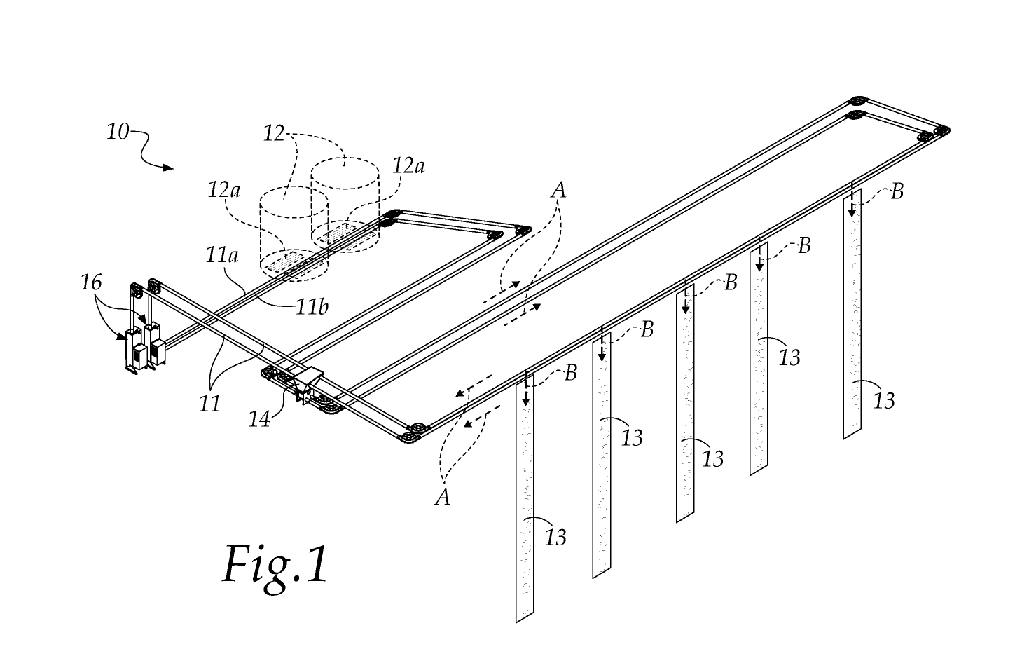

FIG. 1 is a view of an apparatus according to the invention;

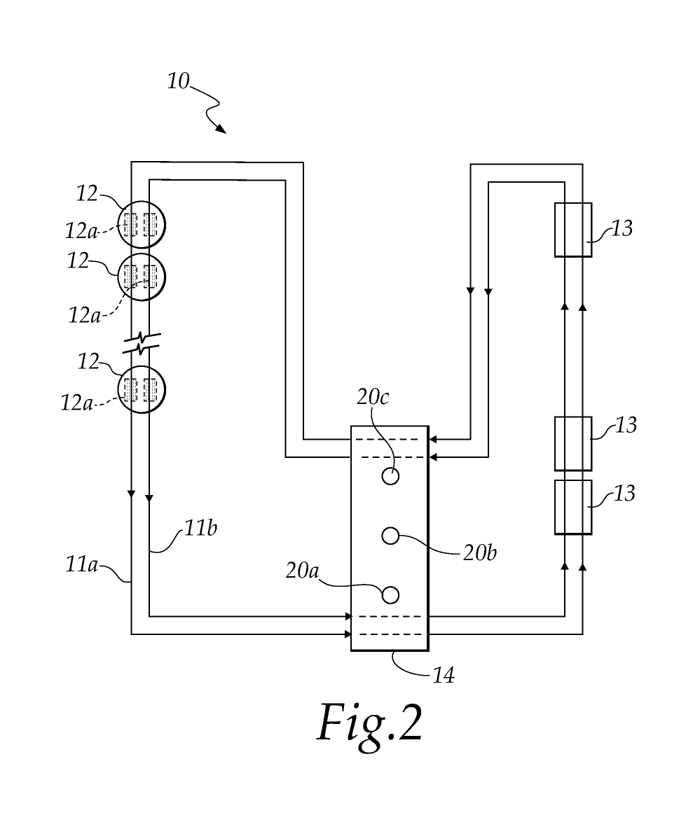

FIG. 2 is a schematic view of an apparatus according to the invention;

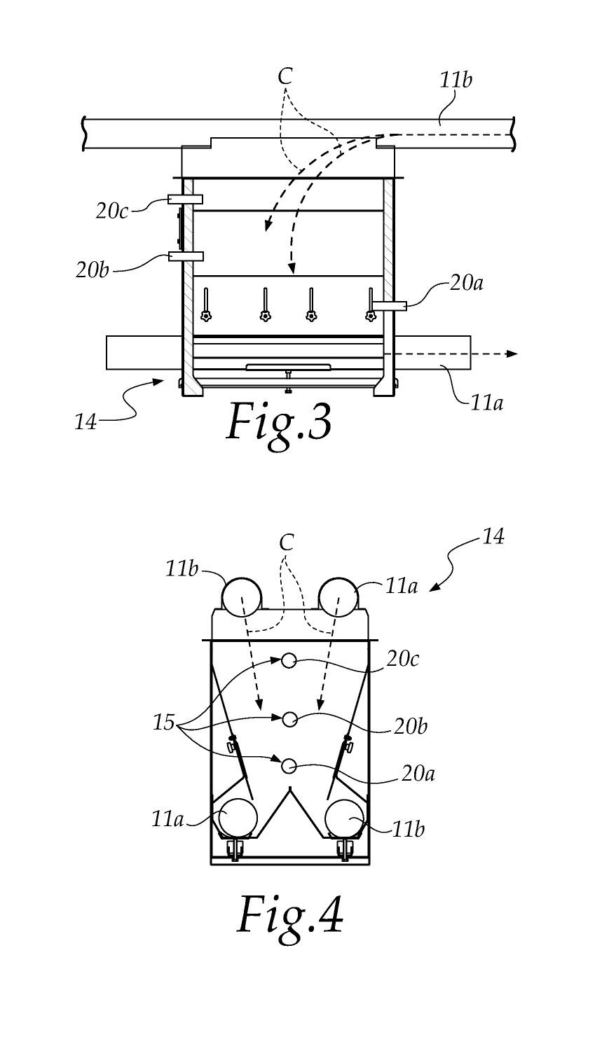

FIG. 3 is a sectional side view of a container for feed, installed in an apparatus according to the invention;

FIG. 4 is a side view of the container at right angles to the cross-section of FIG. 3;

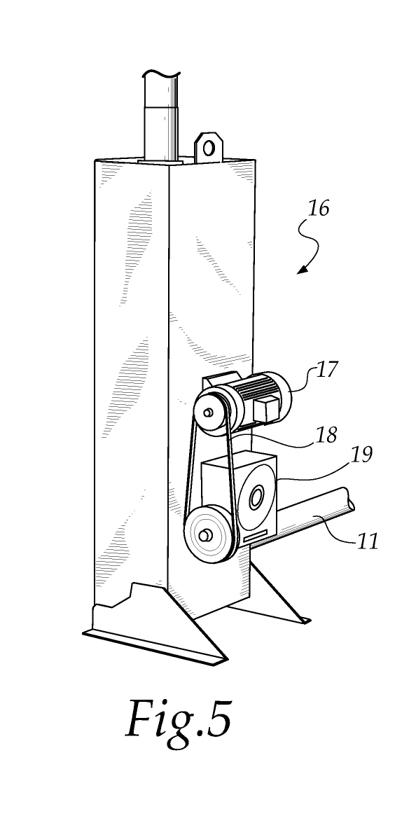

FIG. 5 is a view of a component of the apparatus according to the invention.

With reference to the cited figures, the apparatus according to the invention, generally designated by the reference numeral 10, comprises:
at least one line for the distribution of feed from at least one storage location to a series of dispensers for dispensing the feed to the cages of animals,
at least one feed container which affects said line upstream and downstream of said dispensers respectively for the loading and discharging of feed, on the part of said line, not released to said dispensers,
means for detecting the level of feed inside said container,
at least one control system adapted to receive filling information of said feed container from said detection means and to control the loading of said line with feed from said storage location or from said feed container and to set the travel speed of said line.

The apparatus 10 is shown in its entirety in FIG. 1. In the illustrated example, the apparatus 10 comprises two lines 11, designated respectively by 11a and 11b in this figure and in the subsequent FIG. 2. Moreover, FIG. 1 also schematically shows five dispensers 13; their number may be different and equal to the number of rows of cages that they feed. These dispensers 13, in a poultry facility, consist preferably of ducts in which the food descends by gravity and which should be always full of feed in order to ensure a continuous supply to the feed dispensers of the animals.

The lines 11 are adapted to bring the food to the dispensers 13, following a path along which the chains or screw feeders (or the like), of which they are composed, are drawn by means of adapted traction devices 16.

A traction device 16 is shown in an enlarged-scale view in FIG. 5, wherein the box that contains it is open in order to see its internal elements. Among these, the motor 17, the transmission belt 18 from the motor 17 and a gearmotor 19 with which the line 11 is associated, are visible.

The apparatus 10 can also comprise just one line 11.

The speed of the line 11 (or lines) can be kept constant or variable during the operation of the apparatus. In the first case, the control system activates and deactivates the line, with an on/off control, moving it and stopping it according to the requirements. In the second case, the control system modifies the speed of the line, again according to the requirements.

The feed container 14, besides representing an intermediate feed discharging and loading point, allows to detect the quantity of excess feed at the return of the line 11a, 11b toward the traction device 16. It has a hopper-like shape, open upward to receive the excess feed from the line 11a, 11b, downstream of the duct-like dispensers 13, and has also regions for loading feed to the line 11a, 11b upstream of said dispensers 13.

The detection means 15 comprise at least two sensors 20 adapted to detect the presence of feed inside the container 14, installed therein at different heights.

They are designated in FIG. 3 and in FIG. 4 by 20a, 20b and 20c from the lowest to the highest.

In particular, the first sensor 20a is the sensor for detecting the minimum quantity of feed considered useful for continuous supply to the cages. It cooperates with the control system in returning the information related to the presence of feed up to the level at which it is installed.

The second sensor 20b returns to the control system the information related to the presence of feed up to the level at which it is installed, higher than the preceding one, in order to adjust the speed and the flow rate of the chains, or to deactivate and reactivate (on/off control) the lines in case of operation at constant speed.

The third sensor 20c is a safety sensor, adapted to return to the control system the information related to the presence of feed at a level for which it is necessary to intervene with the disposal of the excess feed, indicating an anomaly in the operation of the lines or an incorrect quantification of the flow rates of feed to the cages.

The storage locations 12 are shown schematically in FIGS. 1 and 2 and consist preferably of silos. Below the locations 12 there are gate valves, designed by the reference numeral 12a, which can be motorized.

FIG. 2 indicates the travelling direction of the lines. It is also shown in FIG. 1 with the arrows designated by A.

In FIG. 1, the descent of feed in the ducts of the dispensers 13 is also designated by B.

In FIG. 3 and in FIG. 4, the discharge of excess feed, returning from the dispensers 13, into the container 14 is designated by C.

The invention also relates to a method for distributing feed with the above described apparatus, which, in normal conditions of operation and using two of said lines, consists in:
with at least one first line of said lines, drawing the feed from at least one of said at least one storage location and said feed container, in passing upstream of said dispensers, and discharging the feed into said container, in passing downstream of said dispensers,
with a second line of said lines, drawing the feed from said container, in passing upstream of said dispensers, discharging it to said dispensers and any excess to said container in passing downstream of said dispensers.

In normal conditions of operation, even without motorized gate valves under the storage locations, the method according to the invention uses the apparatus 10 already described in order to bring the feed level up to the second sensor 20b, thus ensuring that the cages are constantly fed. In fact, if the feed dispensers are full, they do not receive further feed and the excess feed is poured into the container 14 until it reaches the second sensor 20b and thus a second filling level.

In the preparation of the apparatus, the circuit of a first line 11a cooperates with silos, the gate valves of which must be completely open and the discharge hatches of which must be completely closed, thus obtaining a circuit the loading points of which are the silos (i.e., the storage locations 12) and the container 14, upstream of the dispensers 13, and the only discharging point of which is the container 14 itself, downstream of said dispensers 13.

For the circuit of the second line 11b, the gate valves of the silos are kept completely closed and the discharge hatches are kept completely open, obtaining a circuit the loading point of which is the container 14, in passing upstream of the dispensers 13, and the only discharging points of which are the dispensers 13 and said container 14, downstream of said dispensers 13.

The method provides for a step in which with the first line 11a it draws the feed from at least one of the storage locations 12 or from the container 14, in passing upstream of the dispensers 13, and discharges the feed into said container 14, in passing downstream of said dispensers 13.

The second line 11b draws the feed from the container 14, in its passing upstream of the dispensers 13, and discharges it to said lines 13. The feed that is found to be in excess is instead discharged again to the container 14, in passing downstream of the dispensers 13.

The method also comprises the stop of the first line 11a, if the level of feed reaches a second filling level, higher than a first filling level, and therefore if the presence of feed is detected by the second sensor 20b in the container 14.

Substantially, the control system adjusts the speed of the lines 11 according to the following logic.

With the chains motionless, i.e, with the internal battery supply system stopped, the control system actuates the second line 11b at a fixed speed and preferably at 50% of the maximum allowed speed, the first line 11a at high speed, calculated at approximately 90% of the maximum allowed speed, when the three sensors 20a, 20b and 20c do not detect feed. If the first of the sensors 20a, the one at the lowest level, detects feed and the other two do not detect feed, the control system actuates the line 11a at a medium speed, approximately at 40% of the maximum allowed speed. If the first two sensors 20a and 20b detect feed and the third one 20c does not detect feed, the control system actuates the line at low speed, approximately 10% of the maximum speed. If, after a delay of few seconds from when the first two sensors 20a and 20b detect feed, the third one 20c also detects feed, the line 11a is stopped.

In practice, once the second filling level, signaled by the second sensor 20b, has been reached, the first line 11a slows down until it stops. At the same time, the second line 11b remains operational for a predetermined time interval, to be set so as to ensure an even distribution of the feed available in the container on all the dispensers 13 for feeding the rows of cages.

As long as the feed dispensers are full, the dispensers 13 also remain full and do not receive further feed from the second line 11b, with the effect that what has been drawn by the line 11b from the container 14 is discharged again in the same container, therefore keeping stable the level of feed inside it.

At the end of the preset time, the first line 11a is also stopped, leaving the dispenser channels 13 full and the container 14 with feed up to the second filling level.

When instead the feed dispensers are not full, they are able to receive feed, therefore the feed drawn with the second line 11b from the container 14 is discharged to the dispensers 13, producing a drop in the feed level in the container 14, thus making the first line 11a restart.

With the chains in motion, the speeds are set in the following manner.

When the feed level is equal to or higher than the first level, indicated by the first sensor 20a, the control system calculates automatically the speed of the first line 11a by observing over time the first two sensors 20a and 20b. The speed is calculated so as to maintain the feed level in the container as constant as possible, delaying the intervention time of the two sensors.

In a normal system with electric control, operation is of the on/off type, therefore it activates and deactivates the lines.

The speed of the second line 11b can in fact be set in two ways. In one solution it is kept constant, possibly higher than the maximum speed set for the first line 11a. In another solution it is instead calculated by means of a PLC: its value depends on the speed of the first line 11a and is equal to the sum of the latter with an offset value. For example, with an offset value of 10% and a speed of the first line 11a at 30% of the maximum allowed speed, the value of the speed of the second line 11b is equal to 40% of the maximum allowed speed.

The apparatus 10 can operate even with just one line 11.

The invention also relates to a method for the distribution of feed with the above mentioned apparatus, which consists in:
drawing, with at least one of the lines, the feed from the at least one storage location,
distributing the drawn feed to the dispensers,
discharging any excess feed into the feed container, downstream of the dispensers,
if the feed level in the container reaches a second filling level, reducing the speed of the line in travel along the distribution circuit, otherwise drawing again the feed from the at least one storage location.

This method is applied conveniently in case of a stop of a line 11, for example for maintenance thereof, as will be described hereinafter.

With two total and operational lines available, designated as first line 11a and as second line 11b, the drawing openings of the silos 12 are opened at 75% and the ones of the container 14 are opened completely. The loading ports at the dispensers 13 are also opened completely.

The two circuits of the lines 11a, 11b are set up exactly in the same way and accordingly are interchangeable with the prospect of a stop of one of them for maintenance.

The goal of the system is, in this case also, to keep the feed dispensers full, therefore a feed level in the container 14 comprised between the first two levels identifiable with the first two sensors 20a and 20b, without furthermore reaching the third level, which can be identified with the third sensor 20c, and without remaining at a level lower than the first one for too long.

When the system is completely empty, the two lines 11a and 11b are activated and draw the feed from the storage location 12.

The next step of the method provides for the distribution of the drawn feed, by the lines 11a and 11b, to the dispensers 13. In order to reach the dispensers, the lines pass through the container 14 without drawing any additional feed, since the container 14 is still empty.

The feed falls sequentially in the ducts of the dispensers 13, filling them progressively.

Both lines 11 operate at the maximum allowed speed.

When the feed dispensers are full, the dispensers 13 are filled as well. The next step of the method provides for discharging any excess feed in the container for feed 14, downstream of the dispensers 13.

Once the first level has been reached, the control system applies a specific reference speed to the lines.

Thus, when the feed level in the container 14 reaches a first filling level, the speed of the line 11a, 11b travelling along the distribution circuit is reduced.

If the feed level drops below the first filling level, which can be detected with the first sensor 20a, the speed of the lines 11a, 11b travelling along the distribution circuit is increased, preferably bringing it back to the maximum one allowed by the apparatus; otherwise, if the feed level reaches a second filling level, greater than the first one and detectable with the second sensor 20b, the speed is reduced, preferably bringing it back to the minimum allowed speed. If a speed variation device is not present, in the first case the lines are activated (on) and in the second case they are halted (off).

If, after a given time interval, the feed level drops below the second filling level of the feed container 14, which can be detected with the second sensor 20b, the feed is again drawn from the storage location 12, otherwise it is drawn from the feed container 14.

When the feed in the container 14 remains, for a given time interval, equal to or higher than the second filling level, the method comprises the following steps:
stopping the first line 11a;
drawing feed, with the second line 11b, from the feed container 14.

In this last step, the second line 11b is disconnected from the storage location 12, i.e., the silo, by means of the closure of the corresponding gate valve.

Subsequently, if the feed level drops below the second filling level, the method provides for the reactivation of the first line 11a, which draws feed from the storage location 12. The speed in travel along the circuit by the first line 11a will be set equal to the reference speed applied previously to both lines.

The method also comprises the following step: if the feed level in the container 14 drops below the first filling level and remains in this condition for a time that exceeds a preset time interval, the second line 11b is returned to draw feed from the storage location 12.

Substantially, when it is necessary to use maximum flow rates, therefore it is necessary to use always all the available lines, the system also uses the motorized gate valves below the silos, i.e., below the locations 12, which modulate their opening and closure based on need.

In this case, the lines 11a and 11b both go to load the feed, the container 14 controls the filling level with the sensors and, if it is filled too much, the system closes the drawing of feed from the locations 12 by means of the automatic gate valves 12a, to then reopen them when the level drops.

All the speed controls of the lines can be at variable or fixed speed with only on/off control and with minimum, maximum or medium value control.

The operation of the apparatus, according to the invention, is evident from what has been described and in particular from the methods it is evident that the lines, once the feed has been discharged at the various dispensers 13, and before returning to the silos, can discharge the excess feed into the container 14, thus making it recirculate inside a sort of virtual loop.

This allows to design an apparatus in which the installation of independent circuits is not indispensable.

The apparatus, by virtue of sensors adapted to read the feed level inside the container, is capable of establishing whether the feed drawn from the storage locations is sufficient or not to feed the inner dispensers and thus controls the flow rate by adjusting, by means of the control system, the speeds of the lines and/or the quantity of feed dispensed from the storage locations through the control of the opening of the gate valves.

The different lines present in the system can be fed in parallel and can operate independently or in combination, as a function of the detected distribution requirements.

A single line can be sufficient to bring the feed inside the shed and to the dispensers, or if, as in the case presented as an example, there are two lines, it is possible to ensure the supply even in case of a stop of one of them, for example for maintenance purposes.

In practice it has been found that the invention achieves the intended aim and objects, providing an apparatus for distributing feed that allows to avoid situations of overload with excess feed, capable of ensuring an adequate supply of feed to the internal distribution lines and a continuous supply of feed to the animals, even in case of maintenance at one of the lines.

The invention thus conceived is susceptible of numerous modifications and variations, all of which are within the scope of the appended claims; all the details may furthermore be replaced with other technically equivalent elements.

In practice, the materials used, so long as they are compatible with the specific use, as well as the contingent shapes and dimensions, may be any according to the requirements and the state of the art.

The disclosures in Italian Patent Application No. 102018000004808 from which this application claims priority are incorporated herein by reference.

1. An apparatus for distributing feed in farming sheds, comprising:
at least one line for the distribution of feed from at least one storage location to a series of dispensers for dispensing the feed to the cages of animals,
at least one feed container which affects said line upstream and downstream of said dispensers respectively for the loading and discharging of feed, on the part of said line, not released to said dispensers,
means for detecting the level of feed inside said container,
at least one control system adapted to receive filling information of said feed container from said detection means and to control the loading of said line with feed from said storage location or from said feed container and to set the travel speed of said line.

2. The apparatus according to claim 1, wherein said detection means comprise at least two sensors adapted to detect the presence of feed inside said container, installed therein at different heights.

3. The apparatus according to claim 1, wherein said container is open in an upper region in order to receive feed from said line and is also provided with regions for loading the feed to said line.

4. The apparatus according to claim 1, wherein said at least one storage location consists of a silo.

5. A method for distributing feed with the apparatus according to claim 1, which, in normal conditions of operation and using at least two of said lines, consists in:
with at least one first line of said lines, drawing the feed from at least one of said at least one storage location and said feed container, in passing upstream of said dispensers, and discharging the feed into said container, in passing downstream of said dispensers,
with a second line of said lines, drawing the feed from said container, in passing upstream of said dispensers, discharging it to said dispensers and any excess to said container in passing downstream of said dispensers.

6. The method according to claim 5, further comprising the stop of said first line if the level of feed reaches a second filling level which is higher than a first filling level.

7. A method for distributing feed with the apparatus according to claim 1, which consists in:
drawing, with at least one of said lines, the feed from said at least one storage location,
distributing the drawn feed to said dispensers,
discharging any excess feed into said feed container, downstream of said dispensers,
when the feed level in said container reaches a second filling level, reducing the speed of said line travelling along the distribution circuit.

8. The method according to claim 7, further comprising the following steps:
if the feed level in said feed container decreases below the first filling level, increasing the speed of said line travelling along the distribution circuit, otherwise
if the feed level reaches a second filling level, higher than the first one, reducing the speed.

9. The method according to claim 8, further comprising the following step: if, after a certain time interval, the feed level drops below the second filling level of said feed container, drawing feed again from said at least one storage location, otherwise drawing from said feed container.

10. The method according to claim 9, further comprising, in the presence of two lines, when the feed level in said feed container remains, for a given time interval, equal to or greater than said second filling level, the following steps:
stopping a first one of said lines,
drawing feed, with a second one of said lines, from said feed container.

11. The method according to claim 10, further comprising the following step: if the feed level drops below said second filling level, reactivating said first line, which draws feed from said at least one storage location.

12. The method according to claim 11, further comprising the following step: if the feed level in said container drops below the first filling level and remains in this condition for a time that exceeds a preset time interval, returning said second line to draw feed from said at least one storage location.
